(19) United States
(12) Patent Application Publication
(10) Pub. No.: US 2010/0117533 A1
(43) Pub. Date: May 13, 2010

(54) DISCHARGE LAMP COMPRISING A MONOXIDE RADIATION EMITTING MATERIAL

(75) Inventors: Achim Gerhard Rolf Koerber, Kerkrade (NL); Rainer Hilbig, Aachen (DE); Daiyu Hayashi, Aachen (DE); Stefan Schwan, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/594,834

(22) PCT Filed: Apr. 9, 2008
(86) PCT No.: PCT/IB08/51343

§ 371 Date: Oct. 6, 2009

(30) Foreign Application Priority Data
Apr. 13, 2007 (EP) 07106111.3

(51) Int. Cl. H01J 61/18

(52) U.S. Cl. 313/638

(57) ABSTRACT

The invention relates to a discharge lamp comprising a group IVB monoxide radiation emitting material, which allows to greatly improve the features of the lamp due to the superior light emitting properties of the monoxide compound.

### FIELD OF THE INVENTION

The present invention is directed to novel materials for light emitting devices, especially to the field of novel materials for discharge lamps.

### BACKGROUND OF THE INVENTION

Discharge lamps form one of the most prominent, widely used and popular forms of lighting. However, quite a lot of discharge lamps suffer from the drawback that their emitting spectrum suffers from a deficiency of green and red contributions, i.e. that the blue (and UV)-content is too prominent. This is limiting the attainable luminous efficacy of such a discharge vessel.

### SUMMARY OF THE INVENTION

It is an object of the present invention to provide an illumination system which is at least partly able to overcome the above-mentioned drawbacks and especially allows to build a discharge lamp with improved lighting features for a wide range of applications.

This object is solved by a illumination system according to claim 1 of the present invention. Accordingly, an illumination system, especially a discharge lamp is provided, comprising a gaseous monoxide radiation emitting material XO, whereby X is selected out of the group Ti, Zr, Hf or mixtures thereof.

Such an illumination system has shown for a wide range of applications within the present invention to have at least one of the following advantages:

Using such an illumination system, the light-technical properties can for a wide range of applications within the present invention be greatly improved in an easy and effective way.

The luminous efficacy is enhanced compared to a pure group IVB metal-halide discharge

The color co-ordinates x, y are shifted towards the Planck locus (i.e. the discharge is becoming “whiter”)

The color rendering properties are improved.

The materials used are non-toxic and are therefore usable for a wide range of applications within the present invention;

According to a preferred embodiment of the present invention, the light generating discharge is operated within a closed lamp vessel.

The monoxide radiation emitting material XO may be then according to a preferred embodiment of the present invention continuously formed and destroyed in a regenerative chemical cycle, so that the light technical properties of the operating system are staying constant on a time scale larger than one hour.

According to a preferred embodiment of the present invention, the monoxide radiation emitting material is formed in the gas of the operating discharge lamp from at least one, preferably two precursors.

According to a preferred embodiment of the present invention, the coldest spot temperature T_{cs} of the discharge volume is ≦900 K and more preferably T_{cs}≦700K at nominal operation of the illumination system.

This has been shown advantageously for many applications within the present invention, since due to this feature, the properties of the illumination system, especially the lifetime of a system being a discharge lamp, may be greatly improved.

The invention furthermore relates to an Illumination system, especially a discharge lamp, comprising

at least one first transition metal compound, whereby the metal is selected out of the group comprising Ti, Zr, Hf or mixtures thereof

at least one second transition metal compound,

whereby at least one of these first and/or second compounds has a vapor pressure of ≧0.01 Pa at 700 K.

If the vapor pressure of one compound is not known at 700 K, it may be estimated by well-known thermodynamic methods, for example by using the Clausius-Clapeyron equation to extrapolate the vapor pressure curve beyond the temperature range for which literature data are known.

Transition metal compounds in the sense of the present invention especially include metal halides, metal oxides and/or metal oxide halides.

Such an illumination system has shown for a wide range of applications within the present invention to have at least one of the following advantages:

Using such an illumination system, the light-technical properties can for a wide range of applications within the present invention be greatly improved in an easy and effective way:

The luminous efficacy is enhanced compared to a pure group IVB metal-halide discharge

The color co-ordinates x, y are shifted towards the Planck locus (i.e. the discharge is becoming “whiter”)

The color rendering properties are improved.

The materials used are non-toxic and are therefore usable for a wide range of applications within the present invention;

Without being bound to any theory, the inventors believe that by using such a first and second compound, it is possible for a wide range of application that especially the monoxide radiation emitting material is generated in such an extent that it influences the lighting properties of the illumination system.

This is believed to occur in that way that the compounds are diffusing into the hot central region of the discharge, where they are dissociated into the atoms. Then the atoms recombine into the desired monoxides which finally emit the desired molecular radiation.

Surprisingly it has been found that the second compound does not need to be an oxide halide compound for a wide range of applications within the present invention. The source of oxygen is in these embodiments believed to derive from oxygen containing impurities introduced during the manufacturing process or from reactions of the transition metal halide filling with the discharge vessel material (like e.g. SiO₂). In these embodiments it is believed that second compound first reacts with these impurities and/or the SiO₂ to form an intermediate oxide halide compound which then further reacts.

According to a preferred embodiment of the present invention, at least one of these first and/or second compounds has a vapor pressure of ≧0.01 Pa, preferably ≧0.05 Pa and most preferred ≧0.10 Pa at 700 K.

According to a preferred embodiment of the present invention, the at least one second compound comprises a metal, a metal halide, metal oxide and/or metal oxide halide compound, whereby the metal is selected out of the group comprising V, Nb, Ta, Cr, Mo, W or mixtures thereof.

According to a preferred embodiment of the present invention, the ratio of the first compound vs. the second compound (in mol:mol) is ≧0.01:1 and ≦1000:1, preferably ≧0.1:1 and ≦100:1 and most preferred ≧0.5:1 and ≦20:1

According to a preferred embodiment of the present invention, the illumination system comprises a discharge vessel, which is preferably made of amorphous or (poly)crystalline oxides or mixtures thereof, especially those which used in the technology of discharge lamps. Preferably the vessel material is SiO₂ (quartz) or Al₂O₃ (polycrystalline alumina or sapphire). Alternatively, other vessel materials as e.g. soft glass could be used, if protected by a suitable (oxide) coating against attack from the lamp filling.

According to a preferred embodiment of the present invention, the content of the first compound and/or the second compound inside the gas vessel is ≧10⁻¹² mol/cm³ and ≦10⁻⁴ mol/cm³, preferably ≧10⁻¹¹ mol/cm³ and ≦10⁻⁵ mol/cm³.

According to a preferred embodiment of the present invention, the first material is selected out of the group comprising TiF₄, ZrF₄, HfF₄, TiCl₄, ZrCl₄, HfCl₄, TiBr₄, ZrBr₄, HfBr₄, Til₄, Zrl₄, Hfl₄, or mixtures thereof.

According to a preferred embodiment of the present invention, the second material is selected out of the group comprising group VB elements, group VB element halides, group VB element oxide halides, group VIB elements, group VIB element halides, group VIB element oxide halides, or mixtures thereof.

According to a preferred embodiment of the present invention, the discharge lamp is a HID lamp, a dielectric barrier discharge (DBD) lamp, a TL, CFL and/or QL low-pressure discharge lamp either operated electrodeless (capacitively or inductively) in the RF or microwave frequency range and/or with internal electrodes at low frequencies or DC.

In case the illumination system comprises or is an HID or a DBD lamp, it is especially preferred that the content of the first compound and/or the second compound inside the gas vessel is ≧10⁻⁸ mol/cm³ and ≦10⁻⁴ mol/cm³, preferably ≧10⁻⁷ mol/cm³ and ≦10⁻⁵ mol/cm³.

In case the illumination system comprises or is a TL, CFL and/or QL low-pressure discharge lamp, it is especially preferred that the content of the first compound and/or the second compound inside the gas vessel is ≧10⁻¹¹ mol/cm³ and ≦10⁻⁶ mol/cm³, preferably ≧10⁻¹⁰ mol/cm³ and ≦10⁻⁷ mol/cm³.

According to a preferred embodiment of the present invention, the illumination system comprises a gas filling, wherein the gas filling comprises an inert buffer gas. The buffer gas may be a noble gas, nitrogen or mercury. More preferably the buffer gas is selected from the group formed by helium, neon, argon, krypton and xenon or mixtures thereof.

According to a preferred embodiment of the present invention, the coldest spot temperature T_{cs} of the discharge volume is ≦900 K and more preferably T_{cs}≦700 K at nominal operation of the illumination system.

An illumination system according to the present invention may be of use in a broad variety of systems and/or applications, amongst them one or more of the following:

Office lighting systems

household application systems

shop lighting systems,

home lighting systems,

accent lighting systems,

spot lighting systems,

theater lighting systems,

fiber-optics application systems,

projection systems,

self-lit display systems,

pixelated display systems,

segmented display systems,

warning sign systems,

medical lighting application systems,

indicator sign systems, and

decorative lighting systems

portable systems

automotive applications

green house lighting systems

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several embodiments and examples of illumination systems according to the present invention.

FIG. 1 shows a measured and simulated emission spectrum of a discharge lamp according to Example I of the present invention.

FIG. 2 shows a measured and simulated emission spectrum of a discharge lamp according to Example II of the present invention.

FIG. 3 shows a measured and simulated emission spectrum of a discharge lamp according to Example III of the present invention.

FIG. 4 shows a measured emission spectrum of a discharge lamp according to Example IV of the present invention.

FIG. 5 shows a measured emission spectrum of a discharge lamp according to Example V of the present invention.

FIG. 6 shows a measured emission spectrum of a discharge lamp according to Example VI of the present invention.

### EXAMPLE I

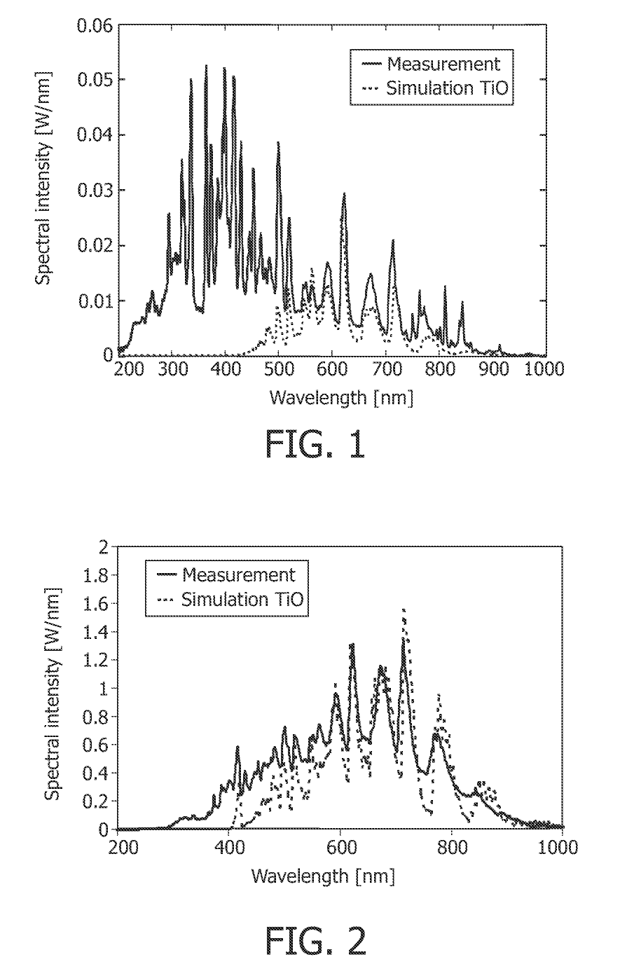

FIG. 1 refers to Example I which was set up as follows:

A tubular quartz envelope with 24 mm inner diameter and 250 mm length, i.e. a volume of 113 ccm, was filled with 0.05 mg Ti, 0.3 mg WCl₆ and 10 mbar Ar (pressure at room temperature). A sufficient amount of oxygen was delivered by reactions with the quartz wall material. 81 W of RF power of 13.56 MHz frequency were capacitively coupled into the lamp by means of external copper electrodes. At a coldest spot temperature of 212° C. the emission spectrum as shown FIG. 1 was measured.

FIG. 1 also contains a simulated spectrum (dashed) emitted by three band systems (A-X, B-X and C-X) of the TiO molecule. It is apparent that this simulation matches the experimental spectrum very well in the green and red visible range and that radiation emitted by TiO molecules contributes a significant amount of the total emitted radiation.

### EXAMPLE II

FIG. 2 refers to Example II which was set up as follows:

A spherical quartz envelope with 32 mm inner diameter, i.e. a volume of 17 ccm, was filled with 0.105 mg Ti, 1.157 mg AuCl₃, 0.36 mg WO₂Cl₂ and 100 mbar Ar (pressure at room temperature). About 630 W of microwave power of 2.45 GHz frequency were coupled into the lamp by placing it into a half-spherical brass resonator. The measured emission spectrum is drawn in FIG. 2. The following light technical data have been derived from this measurement: Chromaticity co-ordinates x=0.3955, y=0.3725 corresponding to a colour temperature T_{c}=3574K, HP red=21.37%, general colour rendering index Ra₈=94.46, luminous flux Φ=481631 m, luminous efficacy ηη=761 m/W, total visible radiation (400.780 nm) Pᵥᵢₛ 243.3 W, total photon quantity=9.17 E20/s corresponding to 1.45 E18 Photons/joule.

FIG. 2 also contains a simulated spectrum (dashed) emitted by three band systems (A-X, B-X and C-X) of the TiO molecule. It is apparent that this simulation matches the experimental spectrum very well over the whole spectral range and that radiation emitted by TiO molecules contributes by far the largest amount of the total emitted radiation.

### EXAMPLE III

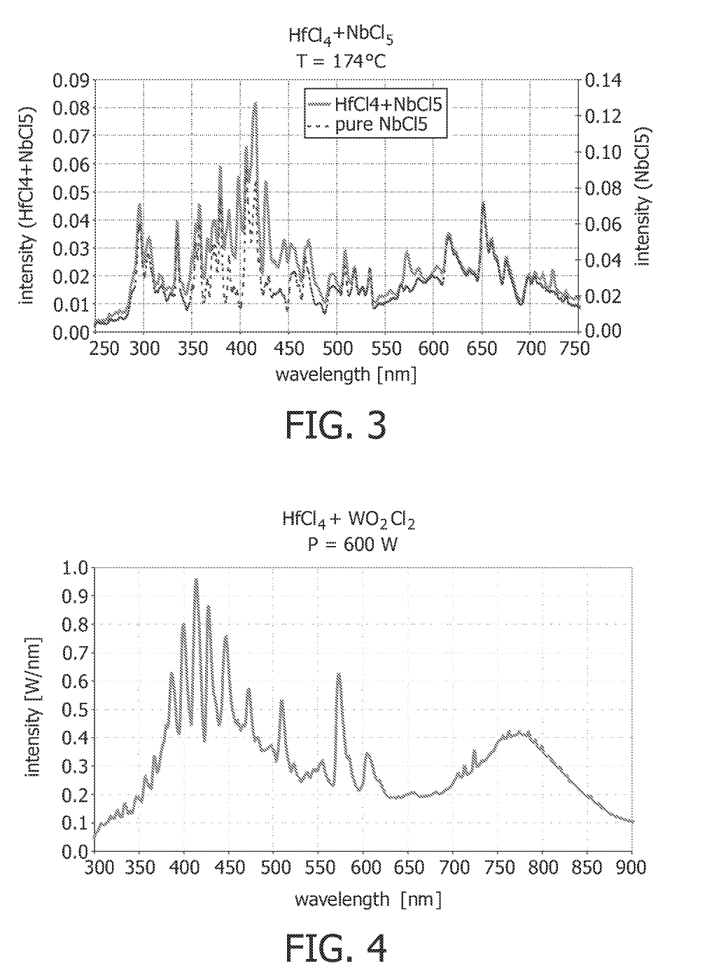

FIG. 3 refers to Example III which was set up as follows:

A tubular quartz envelope with 24 mm inner diameter and 250 mm length, i.e. a volume of 113 ccm, was filled with 0.26 mg HfCl₄, 0.21 mg NbCl₅ and 12 mbar Xe (pressure at room temperature). A sufficient amount of oxygen was delivered by reactions with the quartz wall material. 98 W of RF power of 13.56 MHz frequency were capacitively coupled into the lamp by means of external copper electrodes. At a coldest spot temperature of 174° C. the emission spectrum of FIG. 3 (solid curve) has been measured.

FIG. 3 also contains the spectrum (dashed) emitted from a lamp filled only with NbCl₅ and 12 mbar Xe operated under the same experimental conditions. The additional emission of the embodiment lamp 1 between 350 nm and 600 nm can mainly assigned to radiation from the diatomic HfO. (see also FIG. 4)

### EXAMPLE IV

FIG. 4 refers to Example IV which was set up as follows:

A spherical quartz envelope with 32 mm inner diameter, i.e. a volume of 17 ccm, was filled with 0.96 mg HfCl₄, 0.38 mg WO₂Cl₂ and 100 mbar Ar (pressure at room temperature). About 600 W of microwave power of 2.45 GHz frequency were coupled into the lamp by placing it into a half-spherical brass resonator. The measured emission spectrum is drawn in FIG. 4.

The given spectrum is dominated by the emission of the diatomic HfO molecule. The band structure of the D-X transition (between =370 nm and 500 nm), and the overlapping B-X and A-X transitions (between =550 nm and 650 nm) can be clearly identified.

### EXAMPLE V

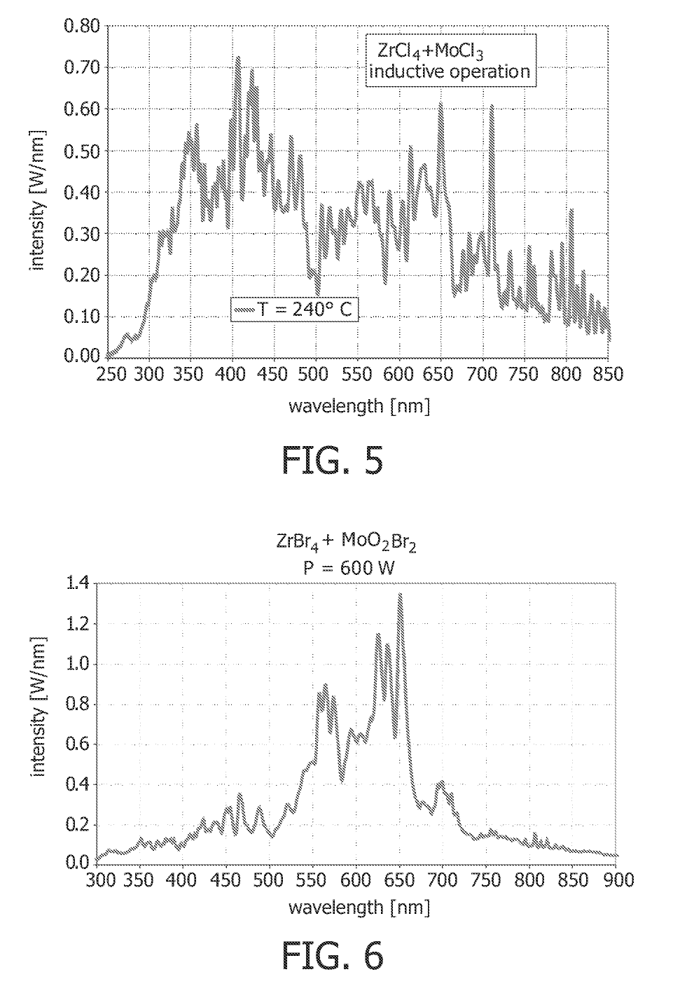

FIG. 5 refers to Example V which was set up as follows:

A tubular quartz tube with 40 mm inner diameter and 90 mm length, i.e. a volume of 145 ccm, was filled with 0.84 mg ZrCl₄, 0.47 mg MoCl₃, 0.25 mg AuCl₃ and 18 mbar Xe (pressure at room temperature). A sufficient amount of oxygen was delivered by reactions with the quartz wall material. 280 W of RF power of 14 MHz frequency were inductively coupled into the lamp by means of an external air coil on the burner (1 mm silver wire, 7 windings). At a coldest spot temperature of 240° C. the emission spectrum of FIG. 5 (solid curve) has been measured.

The emission of the embodiment lamp 3 between 500 nm and 660 nm is mainly due to radiation from the diatomic ZrO (see also FIG. 6).

### EXAMPLE VI

FIG. 6 refers to Example VI which was set up as follows:

A spherical quartz envelope with 32 mm inner diameter, i.e. a volume of 17 ccm, was filled with 1.07 mg ZrBr₄, 0.41 mg MoO₂Br₂ and 100 mbar Ar (pressure at room temperature). About 600 W of microwave power of 2.45 GHz frequency were coupled into the lamp by placing it into a half-spherical brass resonator. The measured emission spectrum is drawn in FIG. 6.

The given spectrum is dominated by the emission of the diatomic ZrO molecule. The band structure of the triplet state transitions f-a (between λ=420 nm and 520 nm), e-a (between λ=530 nm and 600 nm) and the d-a overlapping with the singlet transition B-X (between λ=600 nm and 800 nm) can be clearly identified.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. Illumination system, comprising
a closed vessel defining a discharge volume, and
a monoxide radiation emitting material XO, wherein X is selected from the group consisting of: Ti, Zr, Hf and mixtures thereof.

2. (canceled)

3. Illumination system according to claim 1, whereby the coldest spot temperature T_{cs} of the discharge volume is ≦900 K at nominal operation of the illumination system.

4. Illumination system, comprising a closed vessel defining a discharge volume and containing:
at least one first transition metal compound, wherein the metal is selected from the group consisting of Ti, Zr, Hf and mixtures thereof, and
at least one second transition metal compound, wherein at least one of the first and/or second compounds has a vapor pressure of ≦0.01 Pa at 700 K.

5. Illumination system according to claim 4, wherein the content of the first compound and/or the second compound inside the gas vessel is ≧10⁻¹² mol/cm³ and ≦10⁻⁴ mol/cm³.

6. Illumination system according to claim 4, wherein the first material comprises TiF₄, ZrF₄, HfF₄, TiCl₄, ZrCl₄, HfCl₄, TiBr₄, ZrBr₄, HfBr₄, Til₄, Zrl₄, Hfl₄, or mixtures thereof.

7. Illumination system according to claim 4, wherein the second material is selected from the group consisting of: group VB elements, group VB element halides, group VB element oxide halides, group VIB elements, group VIB element halides, group VIB element oxide halides, and mixtures thereof.

8. Illumination system according to claim 4, wherein the coldest spot temperature T_{cs} of the discharge volume is ≦900 K at nominal operation of the illumination system.

9-10. (canceled)
